(19) United States
(12) Patent Application Publication
(10) Pub. No.: US 2023/0234130 A1
(43) Pub. Date: Jul. 27, 2023

(54) METHOD OF MANUFACTURING GAS PERMEABLE METAL

(71) Applicant: NATIONAL KAOHSIUNG UNIVERSITY OF SCIENCE AND TECHNOLOGY, Kaohsiung City (TW)

(72) Inventors: MENG-HSIU TSAI, KAOHSIUNG CITY (TW); HO-CHUNG FU, KAOHSIUNG CITY (TW); I-LIN LAI, KAOHSIUNG CITY (TW)

(21) Appl. No.: 17/984,801

(22) Filed: Nov. 10, 2022

(30) Foreign Application Priority Data
Jan. 26, 2022 (TW) 111103413

(51) Int. Cl. C23C 24/10

(52) U.S. Cl. CPC C23C 24/106

(57) ABSTRACT

A method of manufacturing a gas permeable metal is provided. First a plurality of metal powder particles is spread out tightly to form a first deposited layer and a second deposited layer is formed over the first deposited layer. Then scan the first and the second deposited layers along a plurality of parallel and spaced linear paths. A gap is formed by a difference between a width of melt pool and a linear distance between the two adjacent linear paths. The linear paths of the first and the second deposited layers are arranged with an angle therebetween. The gaps of the first and the second deposited layers are crossed over to form pores distributed like a grid graph. A plurality of the first and the second deposited layers are stacked and the pores are aligned to form continuous pore channels. Thereby the metal with good venting is produced conveniently.

### BACKGROUND OF THE INVENTION

### Field of the Invention

The present invention relates to a method of manufacturing a gas permeable metal, especially to a method of manufacturing a gas permeable metal by which the gas permeable metal having pores with required size and shape is produced and continuity of the pores is ensured.

### Description of Related Art

Proper venting is the key point to manufacturing defect-free injection molding products. After molten materials flowing into the molding, air/gas which is trapped in the mold will move to the surface of the injection molding product and thus not only result in appearance problems but also impairs physical strength as well. In order to discharge the an gas trapped in the mold, a venting passage should be provided and arranged at an adequate position by experienced technicians. However, once the position of the venting passage is arranged at the wrong position, the mold can't be used and the cost of the mold becomes a loss. This leads to the cost burden of mold-making

In order to overcome shortcomings of the molds available now such as poor permeability and difficulty in arrangement of the venting passage, some people in the business have developed gas permeable molds. Please refer to those revealed in Taiwanese granted Pat. Pub. No. 1558568B “permeable metal substrate, metal-supported solid oxide fuel cell, and method of manufacturing the same”, Taiwanese granted Pat. Pub. No. 1413695B “method of manufacturing gas permeable metal or ceramic with high strength”, Taiwanese granted Pat. Pub. No. 1269814B “method of manufacturing gas permeable mold steel”, Taiwanese Pat. Pub. No, 20199982A “porous metal and method of manufacturing the same”, Chinese granted Pat. Pub. No. CN208305508U “highly permeable metal fiber as mold material”, Chinese granted Pat, Pub. No. CN104451234B “method of manufacturing gas permeable metal”, and Chinese granted Pat. Pub. No. CN107868899B “gas permeable steel for injection molding”. These methods of manufacturing gas permeable metals mainly use high temperature sintering techniques. Although the metal produced is gas permeable, pores formed by sintering have different sizes and irregular shapes. The pores are scattered randomly and lacking in continuity, When the respective pores are not connected continuously, the gas permeability is not ensured. Moreover, the metals having the pores with required size, shape, and distribution pattern are unable to be customized. While in use, the problem of poor venting still exists. Thus there is room for improvement and there is a need to provide a novel method of manufacturing gas permeable metals.

SUMMARY OF THE INVENTION

Therefore, it is a primary object of the present invention to provide a method of manufacturing a gas permeable metal by which the gas permeable metal having pores with required size and shape is produced and continuity of the pores is ensured.

In order to achieve the above objects, a method of manufacturing a gas permeable metal according to the present invention includes the following steps. First a plurality of metal powder particles is spread out tightly to form a first deposited layer and a second deposited layer is formed over the first deposited layer. Then scan the first and the second deposited layers along a plurality of first and second linear paths arranged in parallel and spaced apart on the first and the second deposited layers respectively. A linear distance formed between the two adjacent linear paths is larger than a width of melt pool of the respective linear paths. A gap is formed by a difference between the width of melt pool and the linear distance. The first linear path of the first deposited layer and the second linear paths of the second deposited layer are arranged with an angle therebetween. The gaps of the first and the second deposited layers are crossed over each other to form a plurality of pores distributed like a grid graph. A plurality of the first deposited layers and a plurality of the second deposited layers are stacked to a preset thickness while the plurality of pores formed by the gaps of the first and the second deposited layers crossed over each other are aligned correspondingly to form a plurality of continuous pore channels. Thereby the gas permeable metal having the pores with required size, shape, and distribution pattern can be produced by the present method easily and conveniently. The continuity of the pores is also ensured to achieve good venting.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing an embodiment scanned by a laser beam according to the present invention;

FIG. 2 is a schematic drawing showing a first deposited layer and a second deposited layer of an embodiment according to the present. invention;

FIG. 3 is a perspective view showing a gas permeable metal formed by a first deposited layer and a second deposited layer stacked alternately of an embodiment according to the present invention;

FIG. 4 is a sectional view of a gas permeable metal formed by a first deposited layer and a second deposited layer stacked alternately of an embodiment according to the present invention; FIG. 5 are optical microscope (OM) images of a gas permeable metal with different linear distances of an embodiment according to the present invention.

### DETAILED DESCRIPTION OF THE PREFERRED EMBODIMENT

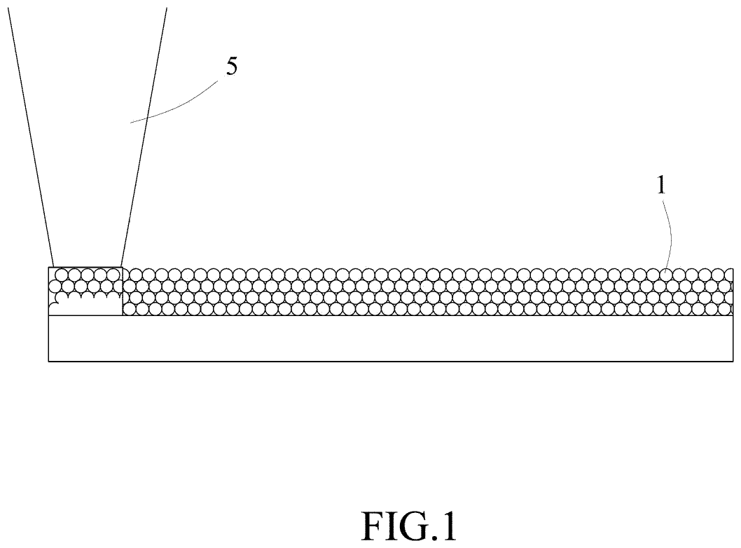

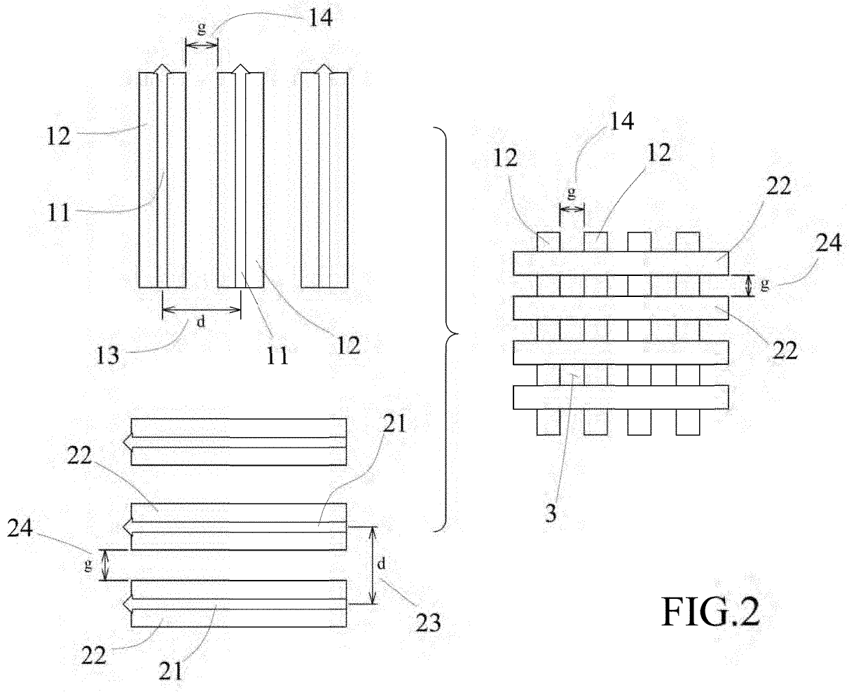

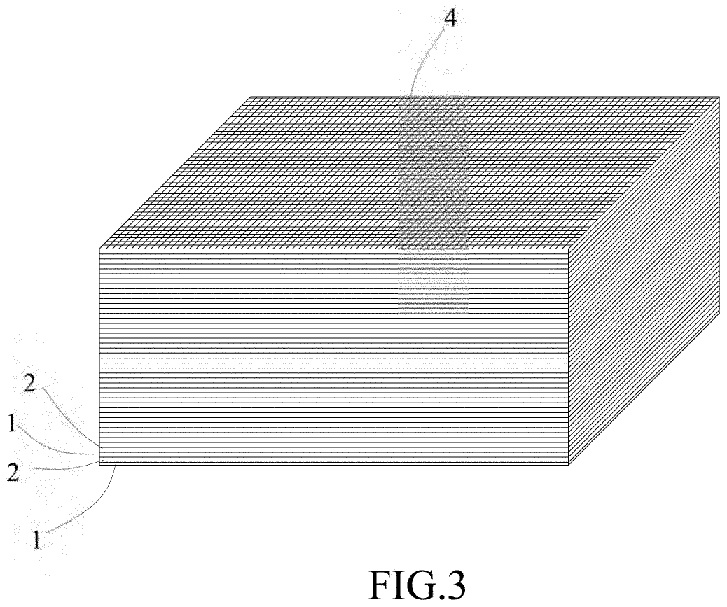

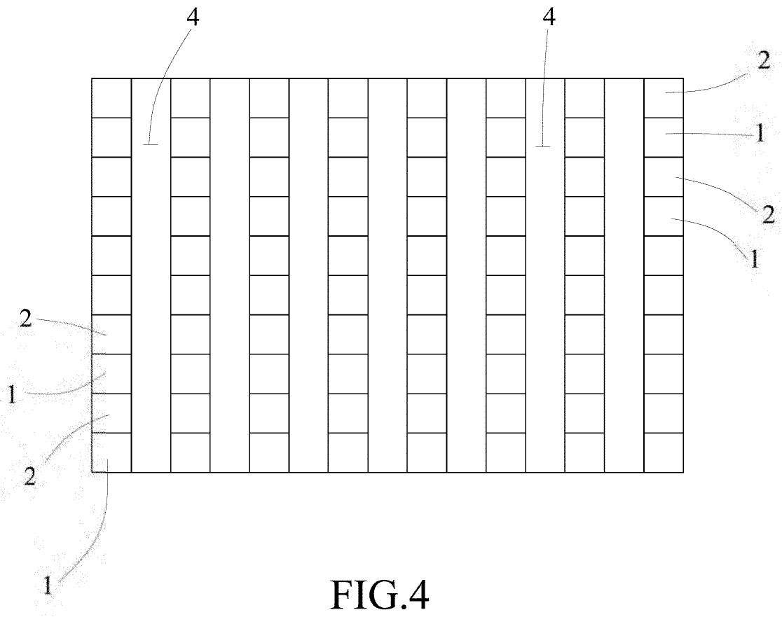

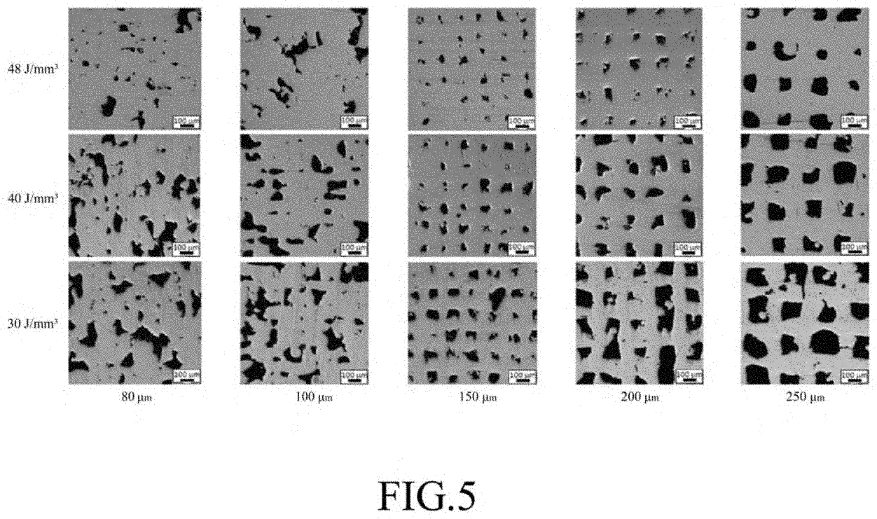

Refer to FIG. 1-4, a method of manufacturing a gas permeable metal according to the present invention includes the following steps.

A. spreading out a plurality of metal powder particles tightly to form a first deposited layer 1 and scanning the first deposited layer 1 by a laser beam 5 along a plurality of first linear paths 11 arranged in parallel and spaced apart on the first deposited layer 1. A first width of melt pool 12 is formed along with each of the first linear paths 11 while a first linear distance 13 (hatch distance) between the two adjacent first linear paths 11 is larger than the first width of melt pool 12 of the first linear path 11. A first gap 14 is formed by a difference between the first width of melt pool 12 and the first linear distance 13. The first gap 14 is equal to the linear distance 13 minus the width of melt pool 12.

B. spreading out a plurality of metal powder particles tightly over the first deposited layer 1 to form a second deposited layer 2 and scanning the second deposited layer 2 by a laser beam 5 along a plurality of second linear paths 21 arranged in parallel and spaced apart on the second deposited layer 2. The second linear path 21 of the second deposited layer 2 and the first linear path 11 of the first deposited layer 1 are disposed with an angle therebetween. Similarly, a second width of melt pool 22 is formed along with the second linear path 21 of the second deposited layer 2 and a second linear distance 23 (hatch distance) between the two adjacent second linear paths 21 is larger than the second width of melt pool 22. A second gap 24 is also formed between the second width of melt pool 22 and the second linear distance 23. The first gap 14 of the first deposited layer 1 and the second gap 24 of the second deposited layer 2 are crossed over each other to form a plurality of pores 3 distributed like a grid graph (also called a lattice graph or a mesh graph). An angle formed between the first gap 14 of the first deposited layer 1 and the second gap 24 of the second deposited layer 2 crossed over each other can be ^{2nd}gap=^{1st} cos (90˜θ). The optimal angle formed between the first gap 14 of the first deposited layer 1 and the second gap 24 of the second deposited layer 2 crossed over each other is 90 degrees.

C. stacking a plurality of the first deposited layers 1 and a plurality of the second deposited layers 2 alternately to a preset thickness while the plurality of pores 3 formed by the first gaps 14 of the first deposited layers 1 and the second gaps 24 of the second deposited layers 2 crossed over each other are aligned correspondingly to form a plurality of continuous pore channels 4.

Thereby a gas permeable metal having the pores 3 with required size, shape, and distribution patterns can be produced by the present method easily and conveniently. The continuity of the pores 3 is also ensured. While the present method being applied to manufacturing of molds, the molds produced have the pores 3 with excellent gas permeability, without blocking air/gas discharge. Moreover, the pores 3 also provide pressure relief during demolding of the injection molding products so that damages caused by pressure difference between the inside and the outside can be avoided. Thus the impact of air/gas trapped on the injection molding products is minimized.

Also refer to FIG. 5, embodiments with the first linear distance 13 and the second linear distance 23 different from each other are revealed. The laser beam 5 keeps at a low energy density state such as 30 J/mm², 40 J/mm² and 48 J/mm². When the first and the second linear distances 13, 23 are smaller than 100 micrometers (μm), the pores 3 are in irregular shapes and distributed randomly. While the first and the second linear distances 13, 23 are increased, to be larger than 150 micrometers (μm), the pores 3 formed by the first gap 14 of the first deposited layer 1 and the second gap 24 of the second deposited layer 2 crossed over each other are obviously are square-shaped and distributed like a grid graph. Thus the gas permeable metal with pores 3 having required size, shape and positions can be customized by the present method easily and conveniently. Not only the customized products can be used more effectively, both production cost and time of the customized products are also significantly reduced.

In summary, the present invention has the following advantages.

1. The gas permeable metal having pores with required size, shape, and distribution pattern can be produced by the present method and continuity of the pores is ensured to get good gas permeability.
2. The gas permeable metal with pores having required size, shape and positions can be customized by the present method. Not only the customized products can be used more effectively, both production cost and time of the customized products are also significantly reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general in inventive concept as defined by the appended claims and their equivalent.

What is claimed is:

1. A method of manufacturing a gas permeable metal comprising the steps of:
A. spreading out a plurality of metal powder particles tightly to form a first deposited layer and scanning the first deposited layer by a laser beam along a plurality of first linear paths arranged in parallel and spaced apart on the first deposited layer; a first width of melt pool is formed along with each of the first linear path while a first linear distance between the two adjacent first linear paths is larger than the first width of melt pool of the first linear path; a first gap is formed by a difference between the first width of melt pool and the first linear distance:
B. spreading out a plurality of metal powder particles tightly over the first deposited layer to form a second deposited layer and scanning the second deposited layer by a laser beam along a plurality of second linear paths arranged in parallel and spaced apart on the second deposited layer; the second linear path of the second deposited layer and the first linear path of the first deposited layer are arranged with an angle therebetween; a second width of melt pool is formed along with the second linear path while a second linear distance foamed between the two adjacent second linear paths is larger than the second width of melt pool; a second gap is formed between the second width of melt pool and the second linear distance; the first gap of the first deposited layer and the second gap of the second deposited layer are crossed over each other to form a plurality of pores distributed like a grid graph;
C. stacking a plurality of the first deposited layers and a plurality of the second deposited layers alternately to a preset thickness while the plurality of pores formed by the first gaps of the first deposited layers and the second gaps of the second deposited layers crossed over each other are aligned correspondingly to form a plurality of continuous pore channels.

2. The method as claimed in claim 1, wherein an angle formed between the first gap of the first deposited layer and the second gap of the second deposited layer crossed over each other is ^{2nd}gap=^{1st} cos(90-θ).

3. The method as claimed in claim 2, wherein the angle formed between the first gap of the first deposited layer and the second gap of the second deposited layer crossed over each other is optimally 90 degrees.

4. The method as claimed in claim 1, wherein the first linear distance of the first deposited layer and the second linear distance of the second deposited layer are both larger than 150 micrometers (μm).
